(19) United States
(12) Patent Application Publication
(10) Pub. No.: US 2021/0209205 A1
(43) Pub. Date: Jul. 8, 2021

(54) REGULATING ACCESS

(71) Applicant: Hewlett-Packard Development Company, L.P., Spring, TX (US)

(72) Inventors: Adrian Baldwin, Bristol (GB); Stuart Lees, Bristol (GB); David Plaquin, Bristol (GB)

(73) Assignee: Hewlett-Packard Development Company, L.P., Spring, TX (US)

(21) Appl. No.: 16/754,846

(22) PCT Filed: Oct. 30, 2017
(86) PCT No.: PCT/US2017/059040

§ 371 Date: Apr. 9, 2020

(51) Int. Cl. G06F 21/31; G06F 21/57; G06F 21/60; G06F 21/46

(52) U.S. Cl. CPC G06F 21/31; G06F 21/572; G06F 21/46; G06F 21/602; G06F 21/604

(57) ABSTRACT

A method for regulating access to a system BIOS comprises generating an access token for a user providing selected BIOS access privileges according to a system policy for the user.

### BACKGROUND

With PC factory provisioning, PCs can be provisioned with both a corporate windows image and a given BIOS setting including a password. In this way some customers have different BIOS passwords for different models or even different machines of the same model. Alternatively, BIOS passwords can be applied by IT departments when receiving PCs, or by users.

In an example strategy, the same password may be applied for all devices, and this password can be shared between multiple administrators. Physical access to devices may be necessary for some functions and having the same password for all machines of a given model (within a given refresh cycle) ensures a consistent approach. In another example strategy, slightly different passwords may be provided which may be based on a standard root or part of a device serial number, where care is taken with the root.

### BRIEF DESCRIPTION OF THE DRAWINGS

Various features of certain examples will be apparent from the detailed description which follows, taken in conjunction with the accompanying drawings, which together illustrate, by way of example only, a number of features, and wherein:

FIG. 1 is a schematic showing a system for regulating access to a system BIOS according to an example;

FIGS. 2-4 each show a flow chart of a method for regulating access to a system BIOS according to an example; and

FIG. 5 is a processor associated with a memory comprising computer readable instructions according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

A BIOS admin password can be set and managed on hardware. For example, at boot time a BIOS admin password can be used to gain access to “F10” BIOS configuration functions, which can be security critical functions (such as enabling secure boot or determining the boot order of devices) and which allow security features to be enabled/disabled.

Administrator BIOS password management can have a single BIOS administration password, where the single password in the BIOS can be shared amongst engineers and administrators. BIOS passwords can be periodically changed or be removed to enable (amongst other things) access or changes to be made.

Windows Management Instrumentations (WMIs) allow BIOS features to be configured and managed. These are supported by a local administration tool as well as through a System Centre Configuration Manager (SCCM or ConfigMgr) plugins. The password management may involve sending a password through to the BIOS, where the password management tool can allow the admin password to be encrypted into binary code which is provided to the command line tool that allows BIOS setting changes. BIOS settings may then be changed after a reboot. However, not all BIOS settings can be changed through a WMI call since a reset of some features can only be reset using “F10” BIOS configuration functions in order to demonstrate physical presence.

According to an example, a password management service is provided to manage passwords linked via an administrator application. The application can, for example, be provided on a smart phone or other suitable portable device. A system is provided to control access to a system BIOS such that someone wishing to access a BIOS requests a temporary token that can be used to log in for a specified period of time. An interface is provided that enables the user to pull an ID of the system in question and use this as part of the request message. A central management device can authenticate the user. The central management device can generate a token for the specific system. The token can be generated in line with a profile that enables the user to access only those parts of the BIOS which he or she is permitted to access.

A password manager service is provided within an enterprise (or other location for a smaller organisation) and that can provide admins or engineers access to temporary (time and function limited) Bios admin passwords. This is coupled with an interface such as a smart phone app to aid the interactions between the password manager, Bios and admin. With this combination a system is introduced for supporting enterprise password policy constraints.

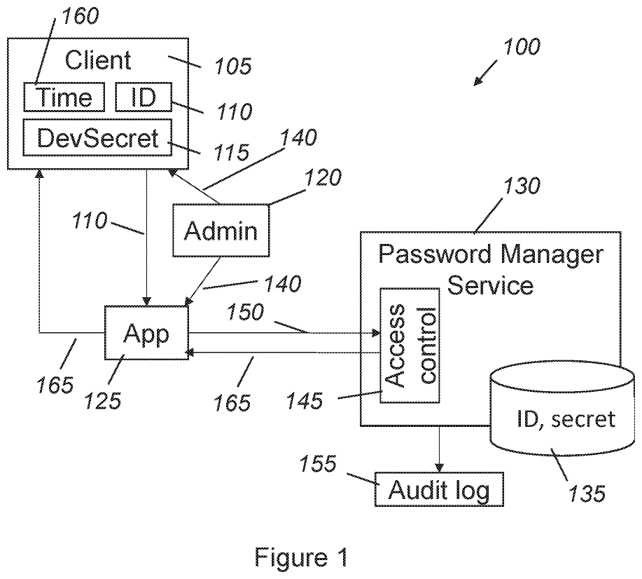

A scheme 100 will now be described, according to an example, with reference to FIG. 1. A client device 105 (assumed to be one of many) can be provisioned with a known ID 110 or serial number and an associated device secret (DevSecret) 115. An administrator 120 has access to a local password manager app 125 or web interface. A central password manager service 130 is provided which holds a copy of the secrets 135 for all devices 105.

When an admin (or engineer) attempts to change BIOS settings on the device 105 he or she can use their local password app 125 to input the identity 110 of the device and a temporary passphrase 140. The app 125 then contacts the central password manager 130 using an appropriate secure channel which may include an enterprise authentication or authorisation framework providing access control 145 restrictions. The ID and admin passphrase are sent in a communication 150 to the password manager. The password manager can then check that the admin is authorised to request access. The password manager may also add the request to an audit log 155, The password manager then uses the time (to an accuracy of the allowed access period) 160, the device ID 110, the device secret 115 and the admin passphrase 140 to generate a temporary ticket 165 to provide access to the device 105 BIOS. The ticket 165 is returned to the admin 120 who supplies it to the client device 105 (for example, via a USB connection or Bluetooth and so on). The admin user can then log into the device 105 using their passphrase 140. This is done by the BIOS using the information it has (i.e. clock, admin passphrase, ID and device secret) to recreate and compare to the ticket 165 (assuming that the admin user is provided with access). In an example, the BIOS is network connected and the protocol can be run directly from the client device allowing the admin to complete an enterprise login.

Alternatively, or additionally, the system may allow access to BIOS features where instead of controlling access, changes can be controlled as they are applied. Thus, it is possible to provide a summary of changes and the ID of the device, and then to request permission to make the changes from the Password Manager Service 130. In an example, the permission may be communicated to the local App 125 using a QR code (or Bluetooth) if the App is running on a smartphone. In this case, the password manager service 130 can then generate an authorisation ticket 165 for the exact changes that have been requested, which may be achieved for example using a keyed-hash message authentication code (HMAC) based on information such as the particular changes, time window, device ID, and/or secret as a key. In this way, the BIOS Password Service 130 can log 155 the actual changes being made. The presentation of the authorisation ticket 165 allows for the changes to be committed to the BIOS. The BIOS Password Service 130 is able to log changes being made (as opposed to only requests for the ability to make changes). Thus, only authorised policies can be applied within a given time window. The time window size may be adapted for different organisations.

In an example, the admin 120 may be tied to a ticket 165 based on the admin providing a passphrase 140. Once the device 105 has received the ticket 165 the admin's passphrase may also be required to be presented to the device 105 to ensure that the device can be unlocked. The ticket 165 may be stored between reboots of the device 105 and the login protected via the admin's passphrase 140.

A variant on the protocol using less communication would use the secret, serial number, time window and access profile to generate a user readable password at the central password manager service. The administrator can then enter this password directly on the PC they are working on along with the access profile. The PC will have sufficient information to check the password.

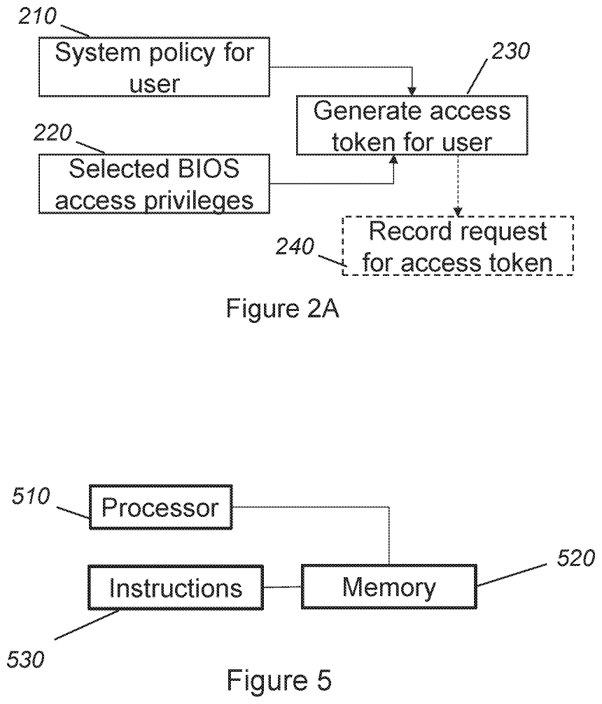

FIG. 2A shows a method for regulating access to a system BIOS according to an example. At block 210 a system policy for a user may be provided outlining a user's access privileges. At block 220 selected BIOS access privileges are provided according to the system policy for the user. At block 230 an access token 165 can be generated for the user. At block 240 the request for the access token is optionally recorded or stored in the audit log 155.

In an example, plugins may be provided to manage BIOS settings from an enterprise management system. For example, policies can be set for a group of devices using a server based plugin. A client agent 105 can pick up a policy from an appropriate distribution point and try to apply it. There may be a plugin for the client that enforces the policy using commands through the BIOS. Policies may be pushed to large groups of devices, where a password may be a standard password or a custom/encrypted password that is deployed on each device. The client plugin ensures that the policy is met and keeps trying to reset the BIOS settings to the correct values. This ensures that they are reset even if the user changes them (for example through an “F10” setting). In an example, passwords may be used within the SCCM, through a local client or through an enterprise management system.

The initialisation or provisioning process will now be described. An initial device secret 115 (DevSecret) may be set for each device (or across all devices) or BIOS password can be set. The device secret 115 can be provisioned into the device using the password management service 130 (the DevSecret may be equivalent to the password but where the password may not necessarily be used directly). In an example, an enterprise public key may be provisioned into the BIOS for auto-generating a random DevSecret 115 which can be encrypted using, for example, the public key for the enterprise. In order to prevent any “man in the middle attacks” any encrypted package 115 can be verified as coming from the client or device 105. For example, this may be achieved by signing the package using a trusted platform module (TPM) hierarchy key. Alternatively, or additionally, the verification of the DevSecret 115 may be provided at boot to an admin who is trusted to ensure that the path over which they receive the password is correct and hence there may be no OS based “man-in-the-middle” attack. The ability to provide an encrypted secret 115 on demand during boot may be a useful backup particularly when the system is not an enterprise one, although it does assume that admin or someone else can adequately backup the private key.

The process by which the admin may obtain the identity of the device will now be described. FIG. 2B shows a method for regulating access to a system BIOS according to an example. At block 250, the admin may enter, via a smartphone app 125, the device 105 serial number or ID 110, or use an encoded ID (such as a serial number encoded in a QR code). In an example, the QR code image can be created during provisioning or generated from the serial number, as shown at block 260. Alternatively, the QR code may be provided on a physical sticker placed on the device 105. In an example, the admin uses the domain name for the device 105 or looks it up via their normal user's login details if there is a suitable enterprise client management database, such as an asset tracking system. In an example, a OR code is scanned with a phone app 125.

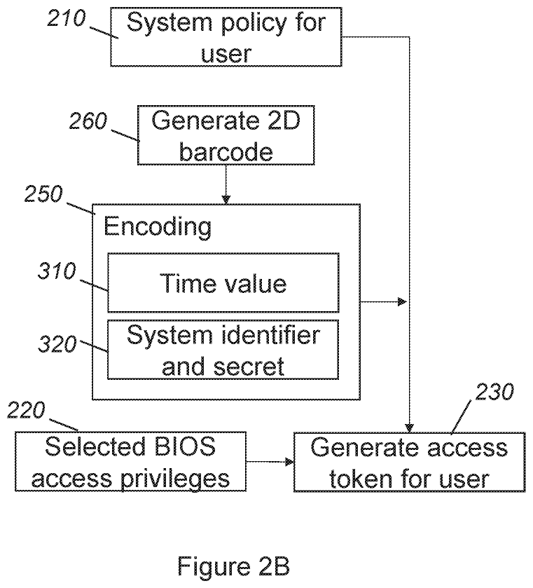

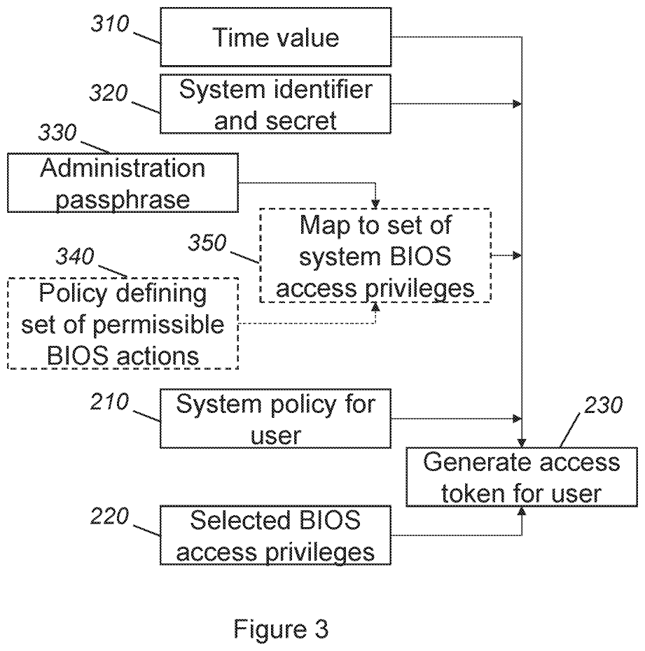

Further aspects are described below with reference to FIGS. 3 and 4. In these figures, blocks 210, 220 and 230 are the same as those described above with reference to FIG. 2A. Those aspects will not therefore be discussed again. Rather, the additional aspects will be described.

FIG. 3 shows a method for regulating access to a system BIOS according to an example. At block 310 a time value is provided to the password manager service 130. At block 320 a system or device ID and secret are provided to the password manager service 130. At block 330 an administration passphrase 140 is provided to the password manager service 130, for example via the App 125. The administrative passphrase may be used with a policy defining a set of permissible BIOS actions for a particular user at block 340 in order to map a set of system BIOS access privileges for the user at block 350. At block 210 a system policy for a user is provided to the password manager service 130. At block 220 selected BIOS access privileges are provided via the temporary ticket 165 according to the system policy for the user. At block 230, the password manager service generates an access token 165 for the user based on the information provided.

“F10” boot-time logins will now be described. In an example, when an admin needs an admin password or passphrase 140 to login to a particular device 105 they login to the password manager 130. This allows the password manager service to perform checks that the admin 120 is authorised to manage the given system 105. In an example, this authorisation check may be performed via an app 125 on a smart-phone, or a web interface, using an enterprise single sign-on.

FIG. 4 shows a method for regulating access to a system BIOS according to an example. At block 410 a request at the client or device 105 is made for a set of system BIOS changes. The request is included in a communication 150 for transmission to the password manager service 130. At block 420 a cryptographic nonce for the client or device 105 is included in a communication 150 for transmission to the password manager service 130. At the password manager service 130, at block 430 the request for the set of system BIOS changes is optionally logged in an audit log 155. Each or all requests can be logged 240 in an audit log 155 for audit purposes. The password manager service 130 optionally checks the admin or engineer or another password manager's credentials to verify whether or not to authorise the request at block 440. In an example, when a communication request 150 for an access token or BIOS changes is sent to the password manager service 130, a standard access control 145 can be applied to allow the admin or engineer access to the device 105 or groups of devices that they manage. In an example, if a user needs access, for example, to boot the device 105 from a USB device to reimage, the user may be given access to only the devices to which they are recorded as using or owning. If the request is authorised the password manager service 130 generates an access token for the admin 120 or user. In an example, the ticket 165 (e.g. AuthEncrypt(secret, <day, tasks, . . . >) (and/or secret 115) may be generated using a key derivation function with the admin passphrase and the DevSecret. At block 450 a message comprising the access token or temporary ticket 165 is transmitted to the app 125 and/or client or device 105. In an example, the BIOS may check the ticket 165 when the admin 120 types in the passphrase 140 (e.g. on an “F10” command) and may check any other conditions on the ticket or limit options accordingly. At block 460 the requested set of system BIOS changes are optionally committed using the access token or temporary ticket or encrypted package 165.

In an example, the password manager service 130 creates a password for the admin 120 to unlock the BIOS at the device 105. In an example, a password may be generated for the current day (or half day as engineers are often on a site for this time period). This may be achieved using the secret 115 and the half day as a seed to a password generator, which may include a secure one-way function. A human usable password of an appropriate length may be generated that admin 120 can type into the device 105. For example; the password 165 generated may have a limited number of characters. Although the password may be time limited it may not be tied into a given user in anyway. In an example, a one-time password function may be used which is based upon an event or a particular time. Alternatively, or additionally, a device such as a smart phone may be used to obtain the password 165. This may be beneficial since it removes the need for admin 120 to type a long, complex password such as an encrypted ticket 165. Further, the encrypted ticket may easily be shared with other devices. For example, if a request is made on the device 105 to be unlocked or for BIOS changes to be made, then the encrypted ticket 165 could be passed via a WMI and stored by the BIOS for the duration of the ticket 165. In an example, if the request 150 is made via a phone; the encrypted ticket 165 may be stored and/or connected as a USB drive, via Bluetooth, or as a QR code, depending upon which BIOS options are available to the device 105. Alternatively, or additionally, a USB stick (e.g. from a laptop) and web interface may be provided to obtain the password 165 from the password manager service 130.

In an example, rather than obtaining approval at the time of the admin or user logging into the BIOS, the BIOS functions may be kept open and require an authorisation when the changes are actually applied. This would change the password management service to one requiring explicit authorisation for any changes at the time of implementation or committing the changes at the device 105. As the changes are saved, the engineer or admin may be presented with a OR code, for example, that contains the change information, ID and cryptographic nonce. This information may then be transmitted back to the password manager service 130 that may optionally log the change request 430 and check authorisations 440 before returning an appropriate ticket 165. The ticket 165 may be handled as described above as a generated password 165 or as a ticket (with or without a passphrase).

Additional, or alternative, features of the password management system 100 will now be described below.

In an example, the password management service 130 may comprise management templates having admin functions that can be combined into a default template. Different default templates may allow different actions, for example, one template may allow changes in the boot parameters (devices, etc) but not allow a reset of certain features. The admin 120 may select or choose the management operations and the access control 145 may be applied at this default level.

In an example, a device BIOS may not have access to an accurate clock. As the device boots it may generate a random code that is used to generate a passphrase that may last for a given time period. Admin 120 can then enter this generated code as well as their passphrase 140 and identity 110 when accessing the password manager service 130. This may be achieved through a OR code as described above with reference to FIG. 2B. In this example, the BIOS is provided with a limited login which has security benefits, since the BIOS associates the generated code with a time-window which is enhances security (albeit using a more complex approach than a “loosely” linked clock).

The following features may apply particularly to a non-enterprise situation, where individuals or SME's may not have the ability to run a secure BIOS Password Manager Service 130. In an example, a cloud-based service may be operated by a laptop manufacturer (or value-added reseller) and linked to a registration of the device, and where the service may be password protected with an appropriate password recovery system. Whilst audit and access control may not be necessary in this example, default templates may be usefully accompanied with warnings to the user around the consequences of changing settings. Such a service may be secured using a two-factor authentication, for example via a local password manager within a customer's phone app which may be backed up via a cloud service. A cloud service may be configured to allow different users to access different sets of BIOS settings.

In an example, in addition to an “F10” login, other password management solution models that can control BIOS settings may provide software on the client or SCCM (or other enterprise management solution). There may be a cloud or desktop-as-a-service (DaaS) based solution provided which allows increased flexibility. For example, with compliance enforcement solutions, such as SCCM, a set of policies may be constantly re-applied and whilst a time-limited password may not be appropriate, there instead may be provided function limited tickets. For example, when enabling a set of changes to be made a script in the form of a set of configuration actions {<set varₓ=val_{y}.>} can be provided, although other actions in other forms may alternatively be provided. For example, a ticket or password may be generated for each action (instead of being generated for a given user using their passphrase), These action generated tickets 165 may optionally be time limited. The BIOS may be unlocked using a ticket containing either a set of hashes for each potential change or a root of a hash tree for the whole script, e.g. PW=f(hash(DevSecret∥hash(cmd)). The ticket may allow any entity to run each command that matches the set, or may need to be accompanied with the path up to the root of the hash tree, or a mixed approach could be taken. The password manager service 130 can still validate the policy or script which is intended to update BIOS settings on the device 105. Thus, the password manager service 130 may require authorisation from a select group of admin 120 or user for the deployment of such scripts. This may be controllable at an enterprise BIOS password manager level and/or there may be provided an authorisation workflow for actions.

In an example, scripts may be reapplied, such as when an admin 120 changes a BIOS setting and then SCCM policies are reapplied to change the BIOS settings back to fit with a corporate policy. Since issuing passwords in this way risks a “replay attack” an additional time field may be added to limit the lifetime of such policies. An example authorisation flow is as follows:

1) The user or SCCM Agent would receive a new policy
2) It would request an authorisation ticket for the policy from the password manager service (note that if all devices had the same DevSecret then this could be a global ticket and delivered with the policy)
3) The SCCM agent would then load the ticket
4) The SCCM agent would try to set each setting
5) Steps 3 and 4 are repeated but the time associated with the ticket is checked and if it has expired a new ticket is requested as with step 2 from the admin/password manager.

In an example, a password management system pushes policies and rather than time limiting the temporary ticket 165, it may be desired to limit changes than can be made to the BIOS. For example, a more complex ticket 165 may be provided which can include the settings that can be applied or the set of settings that can be set by a user.

In an example, a user or admin managing BIOS settings via a PC based interface may use a similar interface to that of an “F10” login. In this example, the user may be authenticated directly on the device (e.g. using standard windows domains). This would allow the request of a temporary ticket 165 that gets pushed to the BIOS via a WMI call. If it is desired for the password manager/software to authenticate a user for each action, a passphrase (or pin) may be provided that forces the user to enter with each command. Alternatively, the password manager/program could manage this. This provides additional protection against user's changing settings.

In an example, as a commission/installation program effecting BIOS changes finishes (or at a timeout on the temporary ticket 165), a blank ticket may be uploaded to prevent further changes to the BIOS.

According to the present disclosure, different access privileges may be provided for different groups of users according to a policy that enables a temporary token to be locked down to specific actions. As such, the need for a single password in the BIOS (that is otherwise shared amongst engineers and administrators) is removed such that the disclosed password management solution meets enterprise password management standards. For example, user account management standards, such as those specified within COBIT, specify that there are risks when accounts are shared or where users have accounts (or passwords) that they no-longer need, e.g. if they have changed roles or left the company. This is particularly important for admin accounts that give privileged rights. For example, the BIOS may be provided with an option to add an administrative password to limit who can change BIOS settings that may include critical security functions. The methods described remove the risks associated with a device password being misused within a time period if the password is leaked.

This disclosure describes a system for making it easier to manage BIOS passwords in a way that also deals with some of the usability aspects via integration into a phone app. The password management service disclosed manages BIOS passwords linked via an admin application which can run on a smart phone (for example). This allows limited use passwords hence controlling who has access to admin functions.

The use of a password manager service 130 coupled with an admin interface 125 (for example, via a smart phone app) provides time, device and functionality limited passwords along with improved accountability in tying their use to individual users and admins. This eases security issues associated with using BIOS passwords and hence encourage more enterprises to use them. Since the methods described do not send a password directly through to the BIOS of a device, they relieve security issues since it is no longer possible to decrypt the password from within the OS. This will help companies have better approaches to BIOS password management which, for those using BIOS passwords, will help streamline their current processes. It may also help encourage others to start using BIOS passwords.

The present disclosure allows for the actions of admins to be tracked in addition to managing or controlling who has access to a Bios admin password. Even if all actions are carried out through policy changes at SCCM this can provide suitable tracking but it does not enable individual actions to fix faults. The present disclosure allows for the actions of admins to be tracked and audit how BIOS admin passwords are being used.

The methods disclosed removes issue surrounding a cloud based service and provisioning to the cloud, where if a customer has not provisioned a device someone else could provision it instead (say having stolen the device). The methods described make it easier to use BIOS password and allow improved device provisioning. For example, provisioning could be linked to an SME certificate or a cloud service provider (or manufacturer) certificate and whilst provisioning the methods disclosed allow the user to enter a passphrase as part of the “DevSecret” so that they would need to provide this to activate a remote service. This removes the threat from someone else using their device if it is stolen.

Examples in the present disclosure can be provided as methods, systems or machine-readable instructions. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

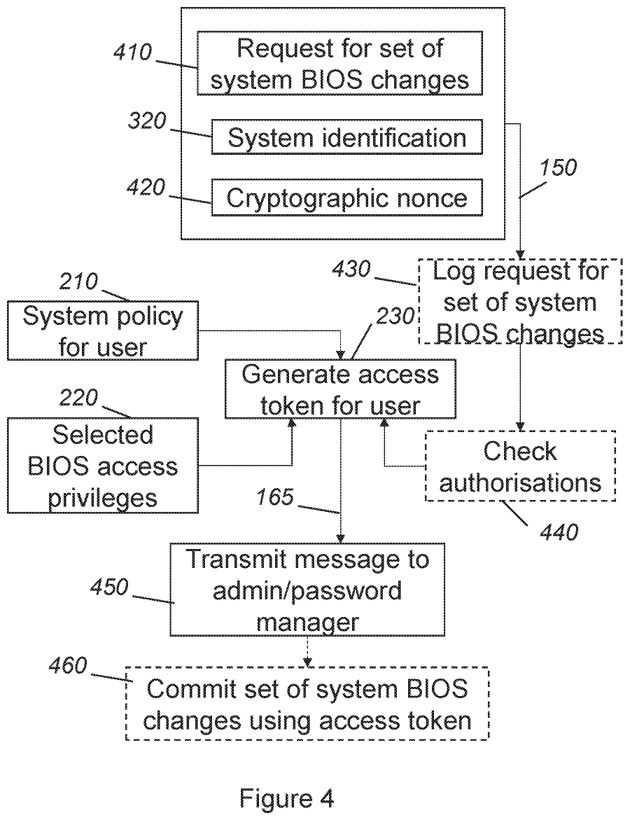

FIG. 5 shows an example of a processor 510 associated with a memory 520. The memory 520 comprises machine readable instructions 530 which are executable by the processor 510. In an example, the instructions 530 comprise:

Instructions to generate an access token for a user providing selected BIOS access privileges according to a system policy for the user;
Instructions to generate the access token at a password manager, using a time value, a system identifier and secret, and an administration passphrase;
Instructions to record a request for an access token in an audit log;
Instructions to map the administration passphrase to a set of system BIOS access privileges using a policy defining a set of permissible BIOS actions;
Instructions to transmit a message comprising a request for a set of system BIOS changes, a system identification and a cryptographic nonce to a password manager;
Instructions to log the request for the set of system BIOS changes;
Instructions to check authorisations;
Instructions to transmit the access token;
Instructions to commit the set of system BIOS changes using the access token; and
Instructions to generate a two-dimensional barcode encoding a time value, a system identifier and secret.

Such machine-readable instructions may also be loaded onto a computer or other programmable data processing devices; so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for regulating access to a system BIOS, the method comprising:
generating an access token for a user providing selected BIOS access privileges according to a system policy for the user.

2. A method, as claimed in claim 1, further comprising:
at a password manager, using at least one of a time value, a system identifier and secret, and an administration passphrase to generate the access token.

3. A method as claimed in claim 1, further comprising:
recording a request for an access token in an audit log.

4. A method as claimed in claim 2, further comprising:
mapping the administration passphrase to a set of system BIOS access privileges using a policy defining a set of permissible BIOS actions.

5. A method as claimed in claim 1, further comprising:
transmitting a message comprising a request for a set of system BIOS changes, a system identification and a cryptographic nonce to a password manager.

6. A method as claimed in claim 5, further comprising:
logging the request for the set of system BIOS changes;
checking authorisations; and
transmitting the access token.

7. A method as claimed in claim 6, further comprising:
committing the set of system BIOS changes using the access token.

8. A method as claimed in claim 1, further comprising:
generating a two-dimensional barcode encoding a time value, a system identifier and secret.

9. A system for regulating access to a device BIOS, the system comprising a password manager service to:
receive a request from an administration application comprising a device secret, device identifier and administrator passphrase; and
generate an access token for a user providing selected BIOS access privileges according to a system policy for the user.

10. A system as claimed in claim 9, the password manager service further to add the request to an audit log.

11. A system as claimed in claim 9, the password manager service further to:
query a system policy for a user to determine user BIOS access privileges.

12. A system as claimed in claim 9, the device to:
receive a temporary passphrase;
recreate the access token using the temporary passphrase and the device secret; and
compare the recreated access token with the generated access token.

13. A non-transitory machine-readable storage medium encoded with instructions executable by a processor for regulating access to a device BIOS, the machine-readable storage medium comprising instructions to:
receive a request from an administration application comprising a device secret, device identifier and administrator passphrase; and
generate an access token for a user providing selected BIOS access privileges according to a system policy for the user.

14. A non-transitory machine-readable storage medium as claimed in claim 13, further encoded with instructions to query a system policy for a user to determine user BIOS access privileges.

15. A non-transitory machine-readable storage medium as claimed in claim 13, further encoded with instructions to
receive a temporary passphrase;
recreate the access token using the temporary passphrase and the device secret; and
compare the recreated access token with the generated access token.
